(19) United States
(12) Patent Application Publication
(10) Pub. No.: US 2023/0291070 A1
(43) Pub. Date: Sep. 14, 2023

(54) BATTERY MODULE HAVING A GAS-BASED FIRE EXTINGUISHING AGENT GUIDE BLADE FOR EXTINGUISHING BATTERY CELL UNIT, AND BATTERY RACK AND ENERGY STORAGE SYSTEM INCLUDING THE BATTERY MODULE

(71) Applicant: LG ENERGY SOLUTION, LTD., Seoul (KR)

(72) Inventors: Hong-Jae PARK, Daejeon (KR); Yo-Hwan KIM, Daejeon (KR); Tae-Shin CHO, Daejeon (KR)

(73) Assignee: LG ENERGY SOLUTION, LTD., Seoul (KR)

(21) Appl. No.: 18/019,136

(22) PCT Filed: Jan. 28, 2022
(86) PCT No.: PCT/KR2022/001640

§ 371 Date: Feb. 1, 2023

(30) Foreign Application Priority Data
Feb. 2, 2021 (KR) 10-2021-0015018

(51) Int. Cl. H01M 50/383; H01M 50/211; H01M 50/503; H01M 50/367; H01M 50/507

(52) U.S. Cl. CPC H01M 50/383; H01M 50/211; H01M 50/367; H01M 50/503; H01M 50/507

(57) ABSTRACT

Discussed is a battery module that may include a cell assembly having battery cells arranged to face each other in an arrangement direction, a bus bar assembly coupled to a side surface of the cell assembly on which electrode leads of the battery cells are located, and guide blades arranged in front of the bus bar assembly in a direction corresponding to the arrangement direction of the battery cells, wherein each of the guide blades can have a plate surface facing at least one battery cell from among the battery cells, and is coupled to the bus bar assembly to rotate by a certain angle due to a gas pressure of a gas, when the gas is generated in the at least one battery cell.

### TECHNICAL FIELD

The present disclosure relates to a battery module, and more particularly, to a battery module capable of effectively injecting a gas-based fire extinguishing agent into a specific battery cell in which an event occurs from among a plurality of battery cells, and a battery rack or an energy storage system including the battery module.

The present application claims priority to Korean Patent Application No. 10-2021-0015018 filed on Feb. 2, 2021 in the Republic of Korea, the disclosures of which are incorporated herein by reference.

### BACKGROUND ART

Because secondary batteries may radically reduce the use of fossil fuel and do not generate any by-products that come with energy consumption, the secondary batteries are gaining attention as a new alternative energy source for improving eco-friendliness and energy efficiency.

Types of secondary batteries that are currently widely used include lithium-ion batteries, lithium polymer batteries, nickel cadmium batteries, nickel hydride batteries, and nickel zinc batteries. An operating voltage per unit battery cell ranges from about 2.5 V to about 4.5 V. When higher output voltage and energy capacity are required, a battery module is configured by connecting a plurality of battery cells in series and in parallel. Also, a battery pack or a battery rack is configured by connecting the battery modules in series and/or in parallel.

Because a secondary battery is accompanied by a chemical reaction during charging/discharging, the performance of the secondary battery may be degraded when the secondary battery is used in an environment higher than an appropriate temperature, and there is a risk of fire or explosion when a temperature rises significantly above the appropriate temperature. In particular, in the case of a battery module having a structure in which a large number of secondary batteries are intensively accommodated, thermal runaway in which heat from one secondary battery spreads to other surrounding secondary batteries may easily occur due to the structure. For this reason, a cooling system and a fire extinguishing system are usually included when a battery module and a battery pack are configured.

In the art, a water injection method of injecting water into a battery pack or a battery module is commonly used as a fire extinguishing system. However, when water is injected into the battery module in order to put out a fire of one specific battery cell, the remaining battery cells will inevitably be damaged by flooding and may not be reused.

Accordingly, there is a demand for a method of applying a halogen compound gas-based extinguishing agent suitable for an electric fire and having less damage than water after fire extinguishing to a fire of a battery module and effectively guiding the gas-based fire extinguishing agent to a specific battery cell in which an event occurs.

### DISCLOSURE

### Technical Problem

The present disclosure is designed to solve the problems of the related art, and therefore the present disclosure is directed to providing a battery module capable of, when an event (gas venting or fire) occurs in a specific battery cell in a battery module, intensively guiding a fire extinguishing agent to the specific battery cell without being introduced into other battery cells.

### Technical Solution

A battery module according to the present disclosure includes: a cell assembly including battery cells arranged to face each other in one direction; a bus bar assembly coupled to a side surface of the cell assembly on which electrode leads of the battery cells are located; and guide blades arranged in front of the bus bar assembly in a direction corresponding to an arrangement direction of the battery cells, wherein each of the guide blades has a plate surface facing at least one battery cell, and is coupled to the bus bar assembly to, when gas is generated in at least battery cell, rotate by a certain angle due to gas pressure.

One guide blade may be provided per battery cell.

Each battery cell may be a pouch-type battery cell with a gas venting guide portion on a side thereof, wherein each guide blade is provided at a position facing the gas venting guide portion of each battery cell.

Each guide blade may include: a guide plate portion provided as a plate-like body capable of shielding a front portion of the gas venting guide portion; and a hinge shaft portion protruding from an upper end and a lower end of the guide plate portion and inserted into an insertion hole formed in the bus bar assembly.

Each guide blade may be coupled to the bus bar assembly so that the guide plate portion is normally parallel to the side surface of the cell assembly.

The hinge shaft portion may include: a shaft vertically passing through the insertion hole; and a latch horizontally protruding from an outer circumferential surface of the shaft, wherein the bus bar assembly includes a stopper that is provided within a radius of rotation of the latch to contact the latch when the latch rotates and is configured to limit a rotation angle of the latch.

The latch may include a convex portion having an arc shape on a surface thereof, and the stopper may include a concave portion having a concave shape conforming to the convex portion.

At least one of the convex portion and the concave portion may be magnetic.

The bus bar assembly may include a bus bar frame including: a body portion including slits through which the electrode leads pass and facing the side surface of the cell assembly; an upper plate portion protruding forward from an upper end of the body portion; and a lower plate portion protruding forward from a lower end of the body portion, and a plurality of bus bars mounted on the body portion and connected in a pre-determined pattern to the electrode leads, wherein an upper end and a lower end of each guide blade are respectively hinged to the upper plate portion and the lower plate portion.

The battery module may further include a module case in which the cell assembly and the bus bar assembly are integrally accommodated, wherein the module case includes, on a side thereof, a fire extinguishing agent injection valve configured to inject a fire extinguishing agent into the module case, wherein an empty space into which the fire extinguishing agent is injected is formed between the guide blades and an inner wall of the module case facing the guide blades.

According to another aspect of the present disclosure, a battery rack includes: a rack housing; the plurality of battery modules arranged in layers in the rack housing; a fire extinguishing agent tank located inside the rack housing or around the rack housing; a pipe connecting the fire extinguishing agent tank to each of the plurality of battery modules; at least one sensor provided in the rack housing and configured to detect whether gas is generated in each battery module; and a controller configured to generate a control signal for, when it is detected by the sensor that gas is generated in each battery module, guiding a fire extinguishing agent to the battery module through the pipe.

The fire extinguishing agent may be a halogen compound fire extinguishing agent.

According to another aspect of the present disclosure, an energy storage system includes the one or more battery racks.

### Advantageous Effects

According to an aspect of the present disclosure, there may be provided a battery module capable of, when an event (gas venting or fire) occurs in a specific battery cell in a battery module, intensively guiding a fire extinguishing agent to the specific battery cell without being introduced into other battery cells.

For example, when an event occurs in a specific battery cell in a battery module, only a guide blade covering the specific battery cell is opened, and thus, a gas-based fire extinguishing agent may be guided into a target battery cell, and may not be introduced into other battery cells or its influence may be minimized. According to the present disclosure, a fire of a specific battery cell and thermal runaway to surrounding battery cells may be easily prevented by injecting a gas-based fire extinguishing agent, and even when the gas-based fire extinguishing agent is injected into a battery module, battery cells other than the specific battery cell may be reused.

### DESCRIPTION OF DRAWINGS

FIG. 1 is a perspective view illustrating a battery rack according to an embodiment of the present disclosure.

FIG. 2 is a reference view for describing a fire extinguishing system of the battery rack of FIG. 1.

FIG. 3 is a view illustrating a configuration of a battery module according to an embodiment of the present disclosure.

FIG. 4 is a perspective view illustrating a cell assembly to which a guide blade is coupled according to an embodiment of the present disclosure.

FIG. 5 is a partial exploded perspective view illustrating a cell assembly according to an embodiment of the present disclosure.

FIG. 6 is a perspective view illustrating an operation of a guide blade when an event occurs in a specific battery cell.

FIG. 7 is a partial enlarged view of FIG. 6.

FIG. 8 is a view corresponding to FIG. 7 according to another embodiment of the present disclosure.

### BEST MODE

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the scope of the disclosure.

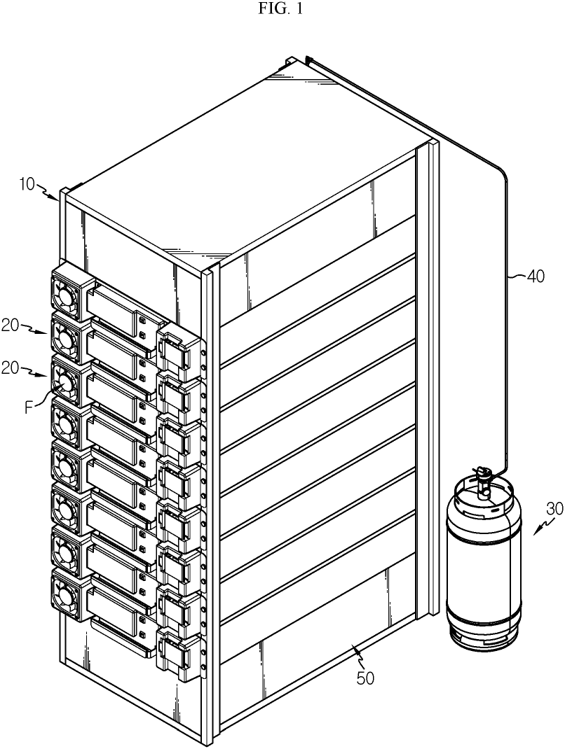

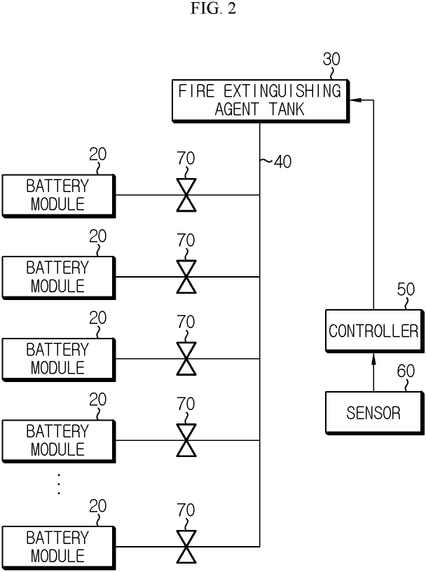

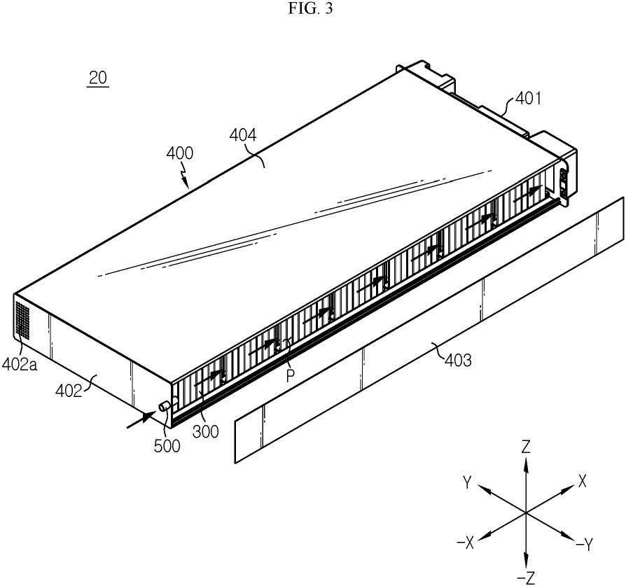

FIG. 1 is a perspective view illustrating a battery rack according to an embodiment of the present disclosure. FIG. 2 is a reference view for describing a fire extinguishing system of the battery rack of FIG. 1. FIG. 3 is a view illustrating a configuration of a battery module according to an embodiment of the present disclosure.

Referring to FIG. 1, a battery rack according to an embodiment of the present disclosure includes a rack housing 10 and a plurality of battery modules 20.

The rack housing 10 may include a plurality of frames, and may be configured so that a plurality of battery modules 20 and a controller 50 are mounted in the rack housing 10.

The plurality of battery modules 20 may be located in layers in the rack housing 10. For example, because the battery modules 20 are accommodated in the rack housing 10 as shown in FIG. 1, space utilization of the battery rack, electrical connection convenience, and energy density may be improved.

Each battery module 20 includes a blower fan F for introducing external air into the battery module 20 as a cooling device. When the blower fan F operates, external air may be introduced into the battery module 20 through an air inlet provided in a left portion of a front surface of the battery module 20 and may flow through cooling channels provided in the cell assembly 100 described below in a +Y axis direction to cool the battery cell 110. The air passing through the cooling channels may be discharged through an air outlet 402a of a rear plate 402 provided on a rear surface of a module case 400 to the outside of the battery module 20.

Due to a structure of the battery rack, when a fire occurs in one battery module 20, flames spread rapidly to other battery modules 20, and there is a risk of fire spread and explosion. Accordingly, it is very important to find the battery module 20 in which the fire first occurs and rapidly extinguish the fire.

Accordingly, the battery rack according to the present disclosure includes a fire extinguishing system including a fire extinguishing agent tank 30, a pipe 40, the controller 50, and a sensor 60.

As shown in FIG. 1, the fire extinguishing agent tank 30 may be located around the rack housing 10, and may be connected through the pipe 40 to each battery module20. Although not shown in detail for convenience of illustration, a portion of the pipe 40 connected to the battery rack may be connected in a manifold type to each battery module 20.

The fire extinguishing agent tank 30 contains a halogen compound fire extinguishing agent. Examples of the halogen compound fire extinguishing agent may include FK-5112 and HFCs-based fire extinguishing agents which are commercially available. The FK-5112 fire extinguishing agent extinguishes a fire by using cooling/asphyxlating fire extinguishing method, and the HFCs-based fire extinguishing agent extinguishes a fire by using a cooling/anti-catalytic fire extinguishing method. These halogen compound fire extinguishing agents are electrically insulating and may minimize additional secondary damage (electrical explosion, shutdown, etc.).

A fire extinguishing system of a battery rack according to the present disclosure will be briefly described with reference to FIG. 2 as follows.

The controller 50 of the battery rack according to the present disclosure may have a function as a battery management system (BMS) for managing charging/discharging of the battery modules 20, may be connected to the sensor 60 and the fire extinguishing agent tank 30, and may be configured to output a control signal for controlling an operation of the fire extinguishing agent tank 30.

The controller 50 monitors gas generation or temperature of all of the battery modules 20. When gas is detected or an abnormal high temperature is detected in a specific battery module 20, the controller outputs an operation signal to the fire extinguishing agent tank 30. For gas or temperature detection of the battery module 20, a plurality of sensors 60 may be provided inside and outside each battery module 20. The sensor 60 detects a rise in temperature and/or ejection of gas of the battery module 20 and transmits a detection signal to the controller 50. For example, the sensor 60 may be a temperature sensor 60, a gas detection sensor 60, or a combination of the temperature sensor 60 and the gas detection sensor 60.

An on/off valve may be provided between the pipe 40 and a fire extinguishing agent injection valve 500 of each battery module 20. The on/off valve may allow a fire extinguishing agent to be supplied or blocked to or from each battery module 20. For example, when gas is generated in a specific battery module 20 from among the plurality of battery modules 20, a control valve 70 connected to the specific battery module 20 may be opened under the control of the controller 50, to inject a fire extinguishing agent into the specific battery module 20.

Next, the battery module 20 according to an embodiment of the present disclosure will be described in detail with reference to FIGS. 3 through 7.

The battery module 20 includes a cell assembly 100, a bus bar assembly 200, guide blades 300, the module case 400, and the fire extinguishing agent injection valve 500.

A plurality of cell assemblies 100 may be provided, and may be accommodated in the module case 400 as shown in FIG. 3. Each of the cell assemblies 100 may include battery modules 110 arranged to face each other in one direction (X axis direction) and cartridges 120 supporting the battery cells 110.

The battery cells 110 are a pouch-type secondary battery in which an electrode assembly (not shown) and an electrolytic solution are sealed with a pouch sheet.

The pouch sheet may include an upper pouch sheet and a lower pouch sheet. The pouch-type secondary battery may be manufactured by locating the electrode assembly and the electrolytic solution at a central portion of the lower pouch sheet, covering the same with the upper pouch sheet, and sealing edges the upper and lower pouch sheets through thermal fusion. In this case, an electrode lead 111 may extend to the inside and the outside of the pouch sheet and a portion of the electrode lead 111 may be fixed between the edges of the upper pouch sheet and the lower pouch sheet through thermal fusion. The electrode lead 111 includes a positive electrode lead and a negative electrode lead and functions as an electrode terminal of the pouch-type secondary battery.

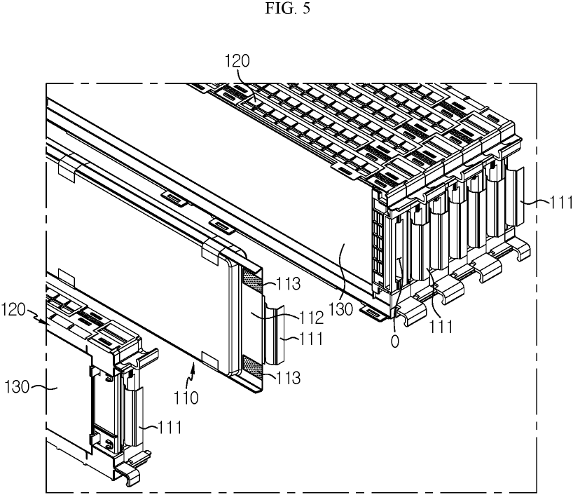

An edge portion of the pouch sheet subj ected to thermal fusion is defined as a sealing portion 112. The pouch-type battery cell 110 of the present disclosure includes a gas venting guide portion 113 in the sealing portion 112 (see FIG. 5). The gas venting guide portion 113 that is a portion where the fusion strength of the pouch sheet is weaker than that of other portions is provided adjacent to the electrode 111. When gas is generated in the battery cell 110 and internal pressure is increased, the gas venting guide portion 113 in the sealing portion 112 may be first damaged and gas may leak therethrough.

The cartridge 120 is an injection molding product for stacking and packaging the battery cells 110. The cartridge 120 may include four frames forming a substantially quadrangular frame shape, and a cooling plate 130 may be attached to an inner space of the quadrangular frame.

Because one or two battery cells 110 are located between two cartridges 120 to which the cooling plate 130 is attached, the battery cell 110 may be fixedly accommodated by the two cartridges 120 with one or both surfaces in contact with the cooling plate 130. In this case, the cartridges 120 may be continuously assembled with each other with the battery cell 110 therebetween, and the electrode lead 111 of each battery cell 110 may be drown out of a gap between the assembled two cartridges 120.

The cooling plate 130 is a thin metal plate having high thermal conductivity such as aluminum, and has a hollow structure to provide a cooling channel through which a refrigerant may flow. When the cooling plate 130 is attached to the cartridge 120, the cooling channel may communicate with openings portion O passing through two frames (short sides) of the cartridge 120. In this configuration, external air may be introduced through the opening portion O on one side of the cartridge 120 into the cooling channel to cool the battery cell 110, and may be discharged through the opening portion on the opposite side of the cartridge 120 to the outside of the cartridge 120.

Although the cell assembly 100 according to the present embodiment includes the cartridges 120, without using the cartridges 120, the battery cells 110 may be directly stacked and may be fixed to the module case 400 through a thermally conductive adhesive or the like. Also, a cooling channel may be formed in an upper portion or a lower portion of the cell assembly 100, so that external air flows along an upper end or lower end edge of the battery cells 110. That is, the scope of the present disclosure is not limited to using the cartridge 120 when the cell assembly is configured.

The bus bar assembly 200 is an electrical component including a bus bar 220 and a bus bar frame 210, and may be mounted on a side surface of the cell assembly 100. The side surface of the cell assembly 100 refers to a portion on which the electrode leads 111 of the battery cells 110 are located.

The bus bar frame 210 may include a body portion 211, an upper plate portion 212, and a lower plate portion 213.

The body portion 211 is a portion facing the side surface of the cell assembly 110, may be detached/attached from/to the cell assembly 1400 in a snap-fit manner, may allow the bus bars 220 to be mounted on a front surface of the body portion 211, and may include slits (not shown) through which the electrode leads 111 may pass.

Although not shown in detail for convenience of illustration, the battery cells 110 may be connected in series and/or in parallel by connecting the electrode leads 111 in a pre-determined pattern to the bus bar 220. For example, positive electrode leads of one or two battery cells 110 are overlapped, pulled out to the front of the body portion 211 through the slits, bent, and welded to any one bus bar 220, and likewise, negative electrode leads of another one or two battery cells 110 are welded to the bus bar 220 to electrically connect the battery cells 110.

The upper plate portion 212 and the lower plate portion 213 are parts for assembling the guide blades 300, and the upper plate portion 212 may protrude forward from an upper end of the body portion 211 and the lower plate portion 213 may protrude forward from a lower end of the body portion 211.

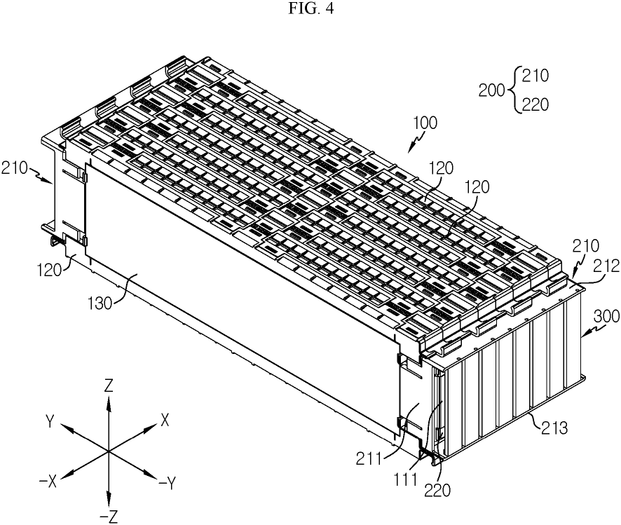

The guide blades 300 are configured to selectively guide a gas-based fire extinguishing agent to the battery cell 110 in which an event occurs from among the battery cells 110. As shown in FIG. 4, the guide blades 300 may be arranged in front of the bus bar assembly 200 in a direction (±X axis direction) corresponding to an arrangement direction of the battery cells 110, and may be configured so that each guide blade 300 has a plate surface facing at least one battery cell 110 and is hinged to the bus bar assembly 200 to, when gas is generated in at least one battery cell 110, rotate by a certain angle due to gas pressure.

It is preferable that one guide blade 300 is provided per battery cell 110. In this case, because, when an event occurs, one guide blade 300 is opened per target battery cell 110 and a gas-based fire extinguishing agent may be guided to the target battery cell 110, other surrounding battery cells 110 may be less affected by the gas-based fire extinguishing agent.

Also, the battery cells 110 of the present embodiment are bidirectional pouch-type battery cells 110 including positive and negative electrode leads located in opposite directions, and include the gas venting guide portion 113 only in one direction. Accordingly, when an event occurs, gas may be guided to a right side of the cell assembly 100. Accordingly, in the present embodiment, each guide blade 300 may be located at a position of each battery cell 110 facing the gas venting guide portion 113, that is, on the right side of the cell assembly 100, and may not be located on a left side of the cell assembly 100 where there is no gas venting guide portion 113.

However, unlike in the present embodiment, the cell assembly 100 may include the battery cells 110 without the gas venting guide portion 113, or due to other factors, the guide blades 300 may be applied to both sides of the cell assembly 100.

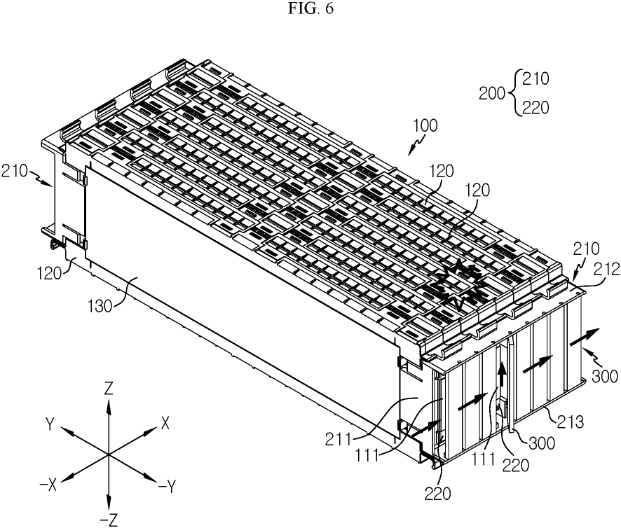

When the guide blades 300 are described in more detail with reference to FIGS. 6 through 8, each guide blade 300 may include a guide plate portion 310 and a hinge shaft portion 320.

The guide plate portion 310 may be provided as a plate-like body capable of shielding a front portion of a corresponding gas venting guide portion 113 (or connection portion between a bus bar and an electrode lead of a corresponding battery cell). The hinge shaft portion 320 that is a portion assembled to the bus bar frame 210 may be provided in a cylindrical shape protruding vertically from an upper end and a lower end of the guide plate portion 310.

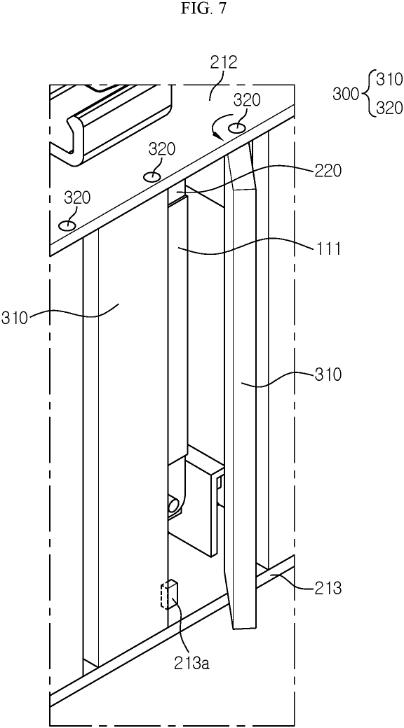

As shown in FIG. 7, an upper hinge shaft portion 320 may be inserted into an insertion hole formed in the upper plate portion 212 of the bus bar frame 210, and a lower hinge shaft portion (not shown) may be inserted into an insertion hole formed in the lower plate portion 213 of the bus bar frame 210. Accordingly, the guide plate portion 310 may rotate forward and backward about the hinge shaft portion 320.

Also, a fixing projection 213a for limiting rotation when the guide plate portion 310 reaches a position parallel to the side surface of the cell assembly 100 may be provided on the lower plate portion 213 of the bus bar frame 210. The fixing projection 213a is a magnetic body, and a magnetic body may be located at a portion of the guide plate portion 310 contacting the fixing projection 213a so that the guide plate portion 310 is normally in contact with the fixing projection 213a, that is, in a closed state.

In this configuration, the guide plate portion 310 is normally parallel to the side surface of the cell assembly 100, to shield the front portion of the gas venting guide portion 113 (or connection portion between the bus bar and the electrode lead of the corresponding battery cell).

However, as shown in FIG. 6, when gas is vented through a certain battery cell 110, the guide blade 300 facing the battery cell 110 rotates to be opened due to pressure of the gas during the venting. In the configuration of FIG. 3, because the fire extinguishing agent injection valve 500 is in a +X direction, a fire extinguishing agent ejected from the fire extinguishing agent injection valve 500 moves in the module case 400 in a direction indicated by an arrow of FIG. 6. In this case, the guide blade 300 facing a battery cell in which gas venting does not occur prevents a fire extinguishing agent from moving in a +Y direction, and the guide blade 300 facing a battery cell in which gas venting occurs is opened by a certain angle, changes a direction of a fire extinguishing agent, and guides the fire extinguishing agent to be injected into the specific battery cell in which the event occurs. That is, because the battery module 20 of the present disclosure is configured so that when gas is vented in a specific battery cell 110, only a specific guide blade 300 facing the specific battery cell 110 is opened, a fire extinguishing agent may be injected into the specific battery cell 110, that is, a target battery cell.

In another example, an angle by which the guide blade 300 is opened by gas pressure when an event occurs may be limited to a specific angle.

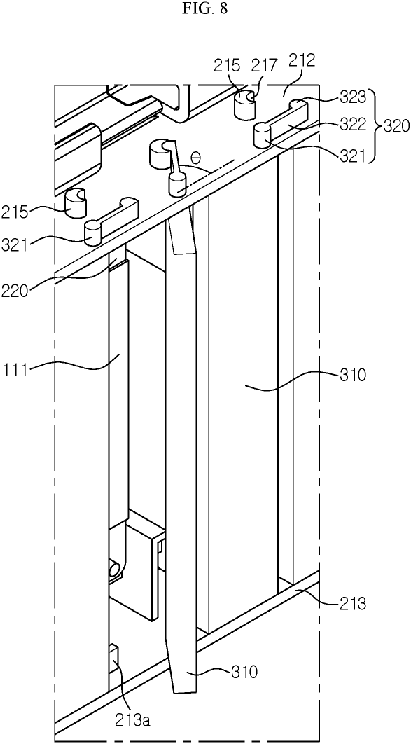

For example, as shown in FIG. 8., the hinge shaft portion 320 of the guide blade 300 according to another example includes a shaft 321 vertically passing through an insertion hole of the bus bar frame 210 and a latch 322 horizontally protruding from an outer circumferential surface of the shaft 321, and the bus bar assembly 200 may further include a stopper 215 that is within a radius of rotation of the latch when the latch 322 rotates and contacts the latch 322 at a position corresponding to the specific angle.

Also, the latch 322 may include a convex portion 323 having an arc shape on a surface thereof, the stopper 215 may include a concave portion 217 having a concave shape conforming to the convex portion 323, and at least one of the convex portion 323 and the concave portion 217 may be provided as a magnetic body.

In this configuration, the guide blade 300 may not be completely opened by gas pressure when an event occurs and an open state may be fixed at a specific angle. For example, the latch 322 of the guide blade 300 may be caught by the stopper 215 of the bus bar frame 210 to limit an opening angle, and the convex portion 323 of the latch 322 may be inserted into the concave portion 217 of the stopper 215 to maintain the opening angle while a gas-based fire extinguishing agent is injected into the target battery cell 110. It may be preferable that the opening angle is about 45° to easily inject the fire extinguishing agent.

The module case 400 includes a front plate 401 (see FIG. 3), the rear plate 402, a pair of side plates 403, a top plate 404, and a bottom plate (not shown), and may have a substantially rectangular parallelepiped shape to integrally accommodate a series of components including the cell assemblies 100.

In the present embodiment, an empty space P into which a fire extinguishing agent may be injected may be formed between the guide blades 300 and an inner wall of the module case 400 facing the guide blades 300, that is, the right side plate 403. When gas is detected in a specific battery cell 110, a fire extinguishing agent may be injected into the module case 400 through the fire extinguishing agent injection valve 500 provided on a right side of the rear plate 402. The fire extinguishing agent may flow from the back to the front of the module case 400 in the empty space P (in X-axis direction) and the flow of the fire extinguishing agent may be guided through the guide blade 300 to the specific battery cell 110.

According to the configuration of the battery module 20 according to an embodiment of the present disclosure as described above, when an event occurs in a specific battery cell, only the guide blade 300 covering the specific battery cell 110 may be opened, and thus, a gas-based fire extinguishing agent may be guided to the specific battery cell 110, that is, a target battery cell 110, and may not be introduced into other battery cells 110 or its influence may be reduced. Accordingly, even when the gas-based fire extinguishing agent is injected into the battery module 20, battery cells other than the specific battery cell 110 may be reused.

An energy storage system according to the present disclosure may include one or more battery racks including the battery modules 20.

The storage energy system may further include a master battery management system (not shown) for integrally controlling the battery modules 20 and the battery racks.

While one or more embodiments of the present disclosure have been described with reference to the embodiments and figures, the present disclosure is not limited thereto, and it will be understood by one of ordinary skill in the art that various changes in form and details may be made therein without departing from the scope of the present disclosure as defined by the following claims.

It will be understood by one of ordinary skill in the art that when terms indicating directions such as upper, lower, left, right, front, and rear are used, these terms are only for convenience of explanation and may vary according to a position of an target object, a position of an observer, etc.

What is claimed is:

1. A battery module comprising:
a cell assembly comprising battery cells arranged to face each other in an arrangement direction;
a bus bar assembly coupled to a side surface of the cell assembly on which electrode leads of the battery cells are located; and
guide blades arranged in front of the bus bar assembly in a direction corresponding to the arrangement direction of the battery cells,
wherein each of the guide blades has a plate surface facing at least one battery cell from among the battery cells, and is coupled to the bus bar assembly to rotate by a certain angle due to a gas pressure of a gas, when the gas is generated in the at least one battery cell.

2. The battery module according to claim 1, wherein one guide blade of the guide blades is provided per a battery cell of the battery cells.

3. The battery module according to claim 1, wherein each battery cell is a pouch-type battery cell with a gas venting guide portion on a side thereof, and
wherein each guide blade is provided at a position facing the gas venting guide portion of each battery cell.

4. The battery module according to claim 3, wherein each guide blade comprises:
a guide plate portion provided as a plate-like body configured to shield a front portion of the gas venting guide portion; and
a hinge shaft portion protruding from an upper end and a lower end of the guide plate portion and inserted into an insertion hole formed in the bus bar assembly.

5. The battery module according to claim 4, wherein each guide blade is coupled to the bus bar assembly so that the guide plate portion is parallel to the side surface of the cell assembly when the gas is not generated.

6. The battery module according to claim 4, wherein the hinge shaft portion comprises:
a shaft vertically passing through the insertion hole; and
a latch horizontally protruding from an outer circumferential surface of the shaft, and
wherein the bus bar assembly comprises a stopper that is provided within a radius of rotation of the latch to contact the latch when the latch rotates and is configured to limit a rotation angle of the latch.

7. The battery module according to claim 6, wherein the latch comprises a convex portion having an arc shape on a surface thereof, and
wherein the stopper comprises a concave portion having a concave shape conforming to the convex portion of the latch.

8. The battery module according to claim 7, wherein at least one of the convex portion and the concave portion is magnetic.

9. The battery module according to claim 1, wherein the bus bar assembly comprises:
a bus bar frame comprising:
a body portion comprising slits through which the electrode leads pass and facing the side surface of the cell assembly;
an upper plate portion protruding forward from an upper end of the body portion; and
a lower plate portion protruding forward from a lower end of the body portion, and
a plurality of bus bars mounted on the body portion and connected in a pre-determined pattern to the electrode leads,
wherein an upper end and a lower end of each guide blade are respectively hinged to the upper plate portion and the lower plate portion.

10. The battery module according to claim 1, further comprising a module case in which the cell assembly and the bus bar assembly are integrally accommodated,
wherein the module case comprises, on a side thereof, a fire extinguishing agent injection valve configured to inject a fire extinguishing agent into the module case, and
wherein an empty space into which the fire extinguishing agent is injected is formed between the guide blades and an inner wall of the module case facing the guide blades.

11. A battery rack comprising:
a rack housing;
battery module according to claim 1 provided in plural, and the plurality of battery modules arranged in layers in the rack housing;
a fire extinguishing agent tank located inside the rack housing or around the rack housing;
a pipe connecting the fire extinguishing agent tank to each battery module of the plurality of battery modules;
at least one sensor provided in the rack housing and configured to detect whether a gas is generated in at least one battery module of the plurality of battery modules; and
a controller configured to generate a control signal for guiding a fire extinguishing agent to the at least one battery module through the pipe, when the at least one sensor detects that the gas is generated in the at least one battery module.

12. The battery rack according to claim 11, wherein the fire extinguishing agent is a halogen compound fire extinguishing agent.

13. An energy storage system comprising at least one battery rack according to claim 11.
